(19) United States
(12) Patent Application Publication
(10) Pub. No.: US 2026/0059066 A1
(43) Pub. Date: Feb. 26, 2026

(54) EFFICIENT COLOR CONVERSION USING MULTIPLE LOOKUP TABLES

(71) Applicant: NVIDIA Corporation, Santa Clara, CA (US)

(72) Inventors: Yanbo Sun, Los Altos, CA (US); Tyvis Chiu Leung Cheung, Queensland (AU); Gennady Petrov, Wesley Chapel, FL (US); Rudolf Bloks, Campbell, CA (US); Harish Chander Rao Vutukuru, San Jose, CA (US)

(21) Appl. No.: 18/813,416

(22) Filed: Aug. 23, 2024

(51) Int. Cl. H04N 1/60; G06T 3/4007

(52) U.S. Cl. CPC H04N 1/6019; G06T 3/4007; H04N 1/6002

(57) ABSTRACT

Disclosed are systems and techniques efficient color conversion. The techniques include receiving a first lookup table (LUT), a corresponding first range, a second LUT, and a corresponding second range. The first range is less than the second range. The techniques include receiving, from a first computer system component, first color data of a first color space. The techniques include, responsive to determining that the first color data is within the first range corresponding to the first LUT, converting the first color data of the first color space to second color data of a second color space using the first LUT. The techniques include providing, to a second computer system component, the second color data of the second color space.

### TECHNICAL FIELD

At least one embodiment pertains to techniques for the efficient conversion of colors using multiple lookup tables.

### BACKGROUND

In computer and video processing systems, color transformations are often performed, such as for tone mapping, color gamut mapping, display panel color correction, and/or creative applications, such as color stretch, custom color effects, and the like. Implementation of these color processing algorithms in hardware or computer shaders can be complex, costly, and have a performance and/or power impact on the system. To overcome these challenges, 3-dimensional lookup tables (3D LUTs) can be used. The 3D LUT can map an input R, G, B color value to a stored output R, G, B color value. The output values can be pre-calculated using any number of operations and stored in memory, so for any given input, the transformation from the input color value to the output color value becomes a simple memory lookup operation.

### BRIEF DESCRIPTION OF THE DRAWINGS

FIG. 1 is a block diagram of an example computer system for efficient color conversion using multiple lookup tables, according to at least one embodiment.

FIG. 2 is a block diagram of an example dual 3D lookup tables (LUTs) circuit for efficient color conversion using multiple lookup tables, according to at least one embodiment.

FIG. 3 is a flow diagram of an example method for efficient color conversion using multiple lookup tables, according to at least one embodiment.

FIG. 4 is a flow diagram of an example method for efficient color conversion using multiple lookup tables, according to at least one embodiment.

FIG. 5 is a block diagram illustrating an exemplary computer system, in accordance with at least one embodiment of the present disclosure.

### DETAILED DESCRIPTION

A 3D LUT for 10-bit color data can require 1024*1024*1024*30 bits=4.03 GB of memory. To reduce memory storage, a sparse representation of the 3D LUT can be used, and an interpolation algorithm (e.g., trilinear, tetrahedral, prism, pyramidal, etc.) can be used to recover the missing entries. It can be advantageous to perform the transformations in a perceptually uniform space, so shaper functions (e.g., gamma and reverse gamma) can be applied to the input color data and/or output color data. In some cases, the shaper functions are implemented as 1D LUTs, such that the R input value is transformed using a first 1D LUT, the G input value is transformed using a second 1D LUT, and the B input value is transformed using a third 1D LUT. There may be corresponding reverse transform 1D LUTs to transform the output R, G, B values.

There is a trade-off between color accuracy and size of the sparse 3D LUT. For example, a 17×17×17 LUT is sufficient for most color transformations in the Standard Dynamic Range (SDR) colors, but it is not enough for High Dynamic Range (HDR) color transforms. For HDR color transformations, 33×33×33 or bigger LUTs are often required. As another example, for organic light-emitting diode (OLED) panel color correction, because of the non-linearity and crosstalk between RGB channels, it can be difficult to use a 17×17×17 LUT to calibrate the panel to perfect color accuracy.

In a 12-bit pipeline, a single 33×33×33 LUT will require 161,717 bytes of memory (e.g., random access memory (RAM) storage), which can be costly for high-performance graphics processing units (GPUs), central processing units (CPUs), and/or systems-on-chip (SoCs) because many instances of such 3D LUTs are often required to support high throughput and multiple data processing pipelines.

The larger LUT also significantly increases the LUT generation time and load time depending on the complexity of the algorithm(s) used to determine the output values and memory bandwidth. Some systems load the entire LUT data within the vertical blanking time, which results in high memory bandwidth demand, especially with reduced blanking times and high refresh rate displays. Other systems double the memory storage of the LUT, so one bank of memory can be loaded during the entire frame time while the other bank of memory is used for lookup operations.

Increasing the size of a small 3D LUT by a factor of 2 in each RGB dimension will result in an almost 8 times increase in memory size and loading time or memory bandwidth. To support dynamic updates over the frame, memory may be further doubled, resulting in an approximately 16 times increase in memory of a single 3D LUT.

The present disclosure addresses these and other technological challenges by providing a system and techniques for efficient color conversion using multiple lookup tables. By using two small (e.g., 17×17×17) 3D LUTs, color accuracy similar to a bigger (e.g., 33×33×33) 3D LUT with dynamic support can be achieved. When both small 3D LUTs are active, one LUT can be used for normal precision color transforms for the entire input range and the other LUT can be used for high precision color transform for a reduced range. Dynamic updates can be achieved by reconfiguring one or both of the 3D LUTs during data processing. For example, to load new 3D LUTs for a new color conversion, the high precision 3D LUT can be disabled temporarily (e.g., for 1 frame) while the normal precision 3D LUT for the new color conversions is loaded from memory. While the high precision 3D LUT is disabled, the normal precision 3D LUT can be used for all transformations. Once the new normal precision 3D LUT is loaded, the old normal precision 3D LUT can be disabled temporarily (e.g., for 1 frame) while the high precision 3D LUT for the new color conversions is loaded from memory. While the new high precision 3D LUT is being loaded into memory, the new normal precision 3D LUT can be used for all transformations.

Thus, either 3D LUT can be loaded and/or configured as a normal precision LUT with a full range or a high precision LUT with a limited range. Switching and reconfiguration between normal and high precision can enable support for dynamic updates with quality only being sacrificed for minimal (e.g., 1, 2, etc.) frames. In some cases, the color error between dual 17×17×17 LUTs described herein and a single 33×33×33 LUT, measured using Delta E 2000 (dE2000), can be below the human vision detectable threshold.

Although dual 3D LUTs and 17×17×17 LUTs are described herein, it should be understood that the ideas disclosed herein can be applied to LUTs of other sizes and numbers. For example, in some embodiments, it may be advantageous to use 2 33×33×33 LUTs. In some embodiments, it may be advantageous to have 2 2D LUTs instead of 2 3D LUTs. In some embodiments, it may be advantageous to use 3 17×17×17 LUTs, each LUT having a different corresponding range.

The advantages of the disclosed techniques include but are not limited to high color conversion accuracy with reduced storage requirements. For example, dual 17×17×17 LUTs can be used as disclosed herein to achieve color conversion accuracy comparable to that of a single 33×33×33 LUT while only requiring approximately 28% of the storage space.

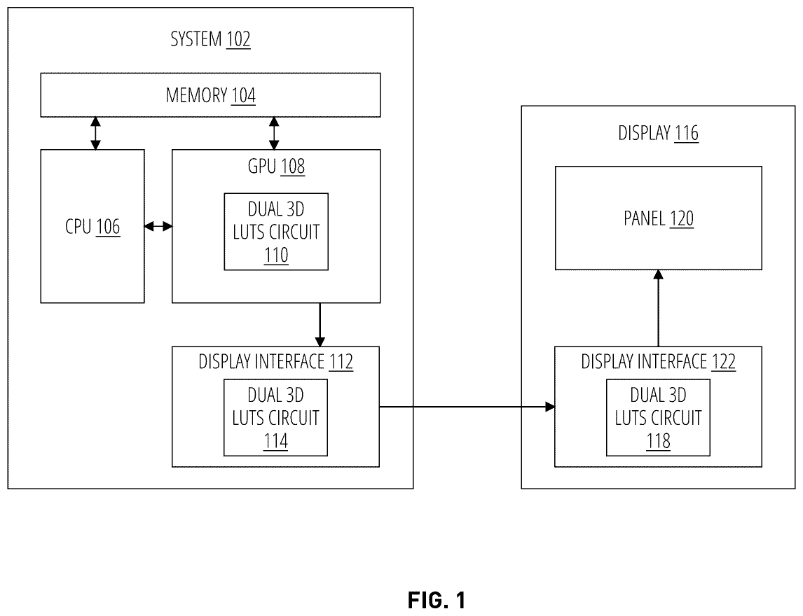

FIG. 1 is a block diagram of an example computer system 102 for efficient color conversion using multiple lookup tables, according to at least one embodiment. System 102 can perform one or more color conversion operations by transforming first color data to second color data using two or more 3D lookup tables (LUTs). System 102 can include memory 104, CPU 106, GPU 108, and display interface 112. Memory 104 can be communicatively coupled to CPU 106 and/or GPU 108. CPU 106 can be connected to GPU 108.

Memory 104 can include one or more registers, one or more caches (e.g., L1 cache, L2 cache, etc.), and/or main memory (e.g., random-access memory (RAM), dynamic RAM (DRAM), static RAM (SRAM), synchronous DRAM (SDRAM), double data rate SDRAM (DDR SDRAM), etc.). Memory 104 can store graphics data (e.g., pixels, images, windows, overlays, composites, etc.), color transformation data (e.g., lookup table values, etc.), and/or the like.

CPU 106 can execute one or more processes based on corresponding instructions (e.g., from memory 104). In some embodiments, CPU 106 can perform color transforms using dual 3D LUTs as described herein. For example, CPU 106 can load two (or more) 3D LUTs from memory 104, load input data (e.g., input color values) from memory 104, transform the input data using the 3D LUTs, and store the output data (e.g., output color values) back to memory 104. In some embodiments, the output data can be provided to another system component.

GPU 108 can include dual 3D LUTs circuit 110 for efficient color conversion performance. GPU 108 can provide input color data to dual 3D LUTs circuit 110 (e.g., during a rendering pipeline, before composition, after composition, etc.) to obtain transformed output color data. In some embodiments, GPU 108 can include a memory device (not shown) for storing graphics data and/or color transformation data.

GPU 108 can be connected to display interface 112. GPU 108 can provide input color data to dual 3D LUTs circuit 110 and transmit the output color data to display interface 112. In some embodiments, GPU 108 transforms color data multiple times before transmitting the output color data to display interface 112. For example, GPU 108 can apply a first color transformation to a first window (e.g., of a graphical user display) and a second color transformation to a second window. GPU 108 can then apply a third color transformation to the composition of the first window and the second window. The output of the third color transformation can be provided to display interface 112.

Display interface 112 can include an interface for transmitting graphics data between system components. For example, display interface 112 can include a video graphics array (VGA) interface, a digital visual interface (DVI), a high-definition multimedia interface (HDMI), a DisplayPort interface, a Mobile Industry Processor Interface (MIPI) Display Serial Interface, and/or the like. In some embodiments, display interface 112 can include dual 3D LUTs circuit 114 for performing one or more efficient color conversions before transmitting the received graphics data to another device. For example, display interface 112 can receive graphics data from GPU 108 and can apply one or more color transformations (e.g., for color correction) before transmitting the output graphics data to display interface 122 of display 116.

System 102 can be connected to display 116 via display interface 112 and display interface 122. Display 116 can include panel 120 for displaying the graphics data from display interface 122. For example, panel 120 can be a liquid crystal display (LCD) panel, a light emitting diode (LED) panel, and/or an organic LED (OLED) panel. Display interface 122 can include dual 3D LUTs circuit 118 and can receive data from system 102 (e.g., via display interface 112). Display interface 122 can provide graphics data received from display interface 112 to dual 3D LUTs circuit 118 for one or more color conversion operations before providing the output data to panel 120. For example, dual 3D LUTs circuit 118 can be configured to apply one or more color correction operations for panel correction before providing the graphics data to panel 120 for display.

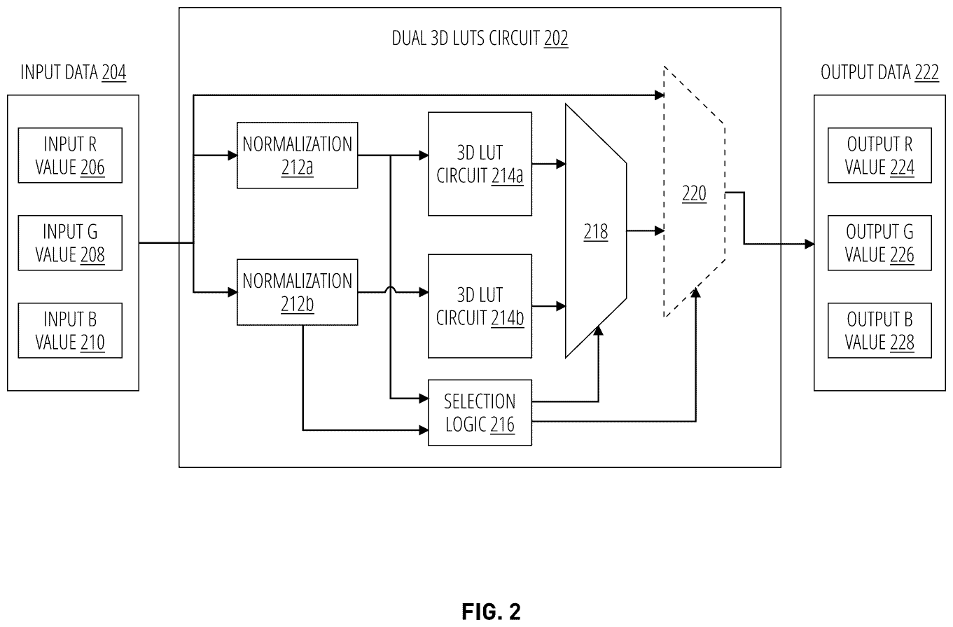

FIG. 2 is a block diagram of an example dual 3D lookup tables (LUTs) circuit 202 for efficient color conversion, according to at least one embodiment. Dual 3D LUTs circuit 202 can include one or more normalization circuits (e.g., normalization 212a, normalization 212b, etc.), two or more 3D LUTs (e.g., 3D LUT circuit 214a, 3D LUT circuit 214b, etc.), selection logic (e.g., selection logic 216), and one or more selectors (e.g., selector 218, selector 220, etc.).

Dual 3D LUTs circuit 202 can be configured to receive input data 204, which can include input R value 206, input G value 208, and input B value 210, and generate output data 222 using the two or more 3D LUTs of dual 3D LUTs circuit 202. Output data 222 can include output R value 224, output G value 226, and output B value 228. In some embodiments, a non-linear transformation has been applied to input data 204 before input data 204 is provided to dual 3D LUTs circuit 202. For example, a gamma correction transformation can be applied to input data 204 before input data 204 is provided to dual 3D LUTs circuit 202. In some embodiments, a reverse (e.g., inverse) non-linear transformation is applied to output data 222 after output data 222 is generated by dual 3D LUTs circuit 202. For example, an inverse gamma correction transformation can be applied to output data 222 after output data 222 is generated by dual 3D LUTs circuit 202.

Normalization 212a and normalization 212b can receive input data 204 and apply one or more normalization operations to input data 204. In some embodiments, normalization 212a can scale input data 204 to cover a range of values corresponding to the 3D LUT stored in 3D LUT circuit 214a. For example, values of input data 204 can have a 10-bit range (e.g., from 0-1023) and the 3D LUT stored in 3D LUT circuit 214a may be configured to receive values between 0-1, so input data 204 can be scaled to fit within the 0-1 range. In some embodiments, normalization 212a can perform rounding operations, clamping operations, and/or offset operations on the scaled values to appropriately align the limited range (e.g., high-precision range) within the input range. Normalization 212b can perform similar operations on input data 204 based on the 3D LUT stored in 3D LUT circuit 214b.

Normalization 212a and normalization 212b can provide their normalized outputs to 3D LUT circuit 214a and 3D LUT circuit 214b, respectively. 3D LUT circuit 214a can store a 3D LUT (e.g., loaded from a memory device) that maps input values to output values. The 3D LUT can be generated by a processing device separate from dual 3D LUTs circuit 202, such as a CPU or GPU. The 3D LUT can be configured such that the output value corresponding to an input value is the result of applying one or more transformation functions (e.g., linear functions, non-linear functions, etc.) to the input value. In some embodiments, 3D LUT circuit 214a and 3D LUT circuit 214b store sparse 3D LUTs and are configured to perform interpolation to obtain the output value corresponding to an input value. For example, 3D LUT circuit 214a can store a 17×17×17 LUT, and if each input value of the input data does not correspond directly with one of the 17 values along its corresponding axis, 3D LUT circuit 214a can perform interpolation to generate the output value. In some embodiments, 3D LUT circuit 214a (and/or 3D LUT circuit 214b) can perform at least one of the following interpolation functions: trilinear interpolation, tetrahedral interpolation, prism interpolation, pyramidal interpolation. In some embodiments, another interpolation function is used to generate the appropriate output value from a sparse LUT based on an input value.

3D LUT circuit 214a and 3D LUT circuit 214b can provide their outputs (e.g., the result of the lookup operation in their respective LUTs) to a selector (e.g., selector 218). In some embodiments, selector 218 can be a multiplexor controlled by selection logic 216.

Selection logic 216 can include a control circuit that is selectively coupled to 3D LUT circuit 214a and 3D LUT circuit 214b. Selection logic 216 can receive normalized input data from normalization 212a and normalization 212b to determine which 3D LUT should be used to transform the input data. For example, each 3D LUT can have a corresponding range of supported input values. Some 3D LUTs can be used for transformations across an entire range of a color space (e.g., all 10-bit values, all 12-bit values, etc.). Some 3D LUTs can be used for transformations across a portion of a range of a color space (e.g., input values between 0-128, input values between 256-512, etc.).

In some embodiments, selection logic 216 receives input data 204 before it has been normalized. In some embodiments, input data 204 is provided to both 3D LUTs regardless of whether input data 204 falls within the range corresponding to the 3D LUT, and the correct transformed value is selected by selection logic 216 using selector 218 based on which range input data 204 falls within. In some embodiments, input data 204 is only provided to the 3D LUT whose range input data 204 falls within.

In some embodiments, dual 3D LUTs circuit 202 includes selector 220. Selection logic 216 can use selector 220 to bypass the 3D LUTs and provide input data 204 as output data 222 without any transformations.

In some embodiments, one of 3D LUT circuit 214a and 3D LUT circuit 214b can be temporarily inactive, during which time selection logic 216 can use the remaining active 3D LUT for all color conversions. For example, 3D LUT circuit 214a can be configured with a 3D LUT for SDR color conversions within a first range, and 3D LUT circuit 214b can be configured with a 3D LUT for HDR color conversions within a second range that covers a portion of the first range. In such a configuration, 3D LUT circuit 214a can be considered a “normal” precision 3D LUT, and 3D LUT circuit 214b can be considered a “high” precision 3D LUT. The “normal” precision 3D LUT and the “high” precision 3D LUT can be considered a pair that are used together.

In some embodiments, a new pair of 3D LUTs can be loaded into dual 3D LUTs circuit 202 over 2 frames. For example, if the 3D LUTs need to be changed to perform a different set of color conversions (e.g., dynamic support), the 3D LUT configured as the “high” precision 3D LUT in the old pair (e.g., 3D LUT circuit 214b in the previous example) can be deactivated and the “normal” precision 3D LUT of the new pair can be loaded from memory into 3D LUT circuit 214b. While the old “high” precision 3D LUT is deactivated, all color transformations can be performed by the old “normal” precision 3D LUT that is still active (3D LUT circuit 214a in the previous example).

The new “normal” precision 3D LUT can be loaded during an entire frame, instead of just during the vertical blanking interval, reducing the memory bandwidth requirements, since the old “normal” precision 3D LUT is still active and can perform all color transformations during the frame the new “normal” precision 3D LUT is being loaded.

Continuing the example, once the new “normal” precision 3D LUT is loaded into 3D LUT circuit 214b, the old “normal” precision 3D LUT in 3D LUT circuit 214a can be deactivated. The new “high” precision 3D LUT can be loaded into 3D LUT circuit 214a during the subsequent frame (e.g., following the frame used to load the new “normal” precision 3D LUT). While the new “high” precision 3D LUT is being loaded, the new “normal” precision 3D LUT in 3D LUT circuit 214b can perform all color transformations. After the new “high” precision 3D LUT is loaded into 3D LUT circuit 214a, selection logic 216 can continue determining between the two 3D LUTs based on the input data. Thus, the 3D LUTs can be updated over two frames, and the “high” precision and “normal” precision 3D LUTs can alternate between 3D LUT circuit 214a and 3D LUT circuit 214b.

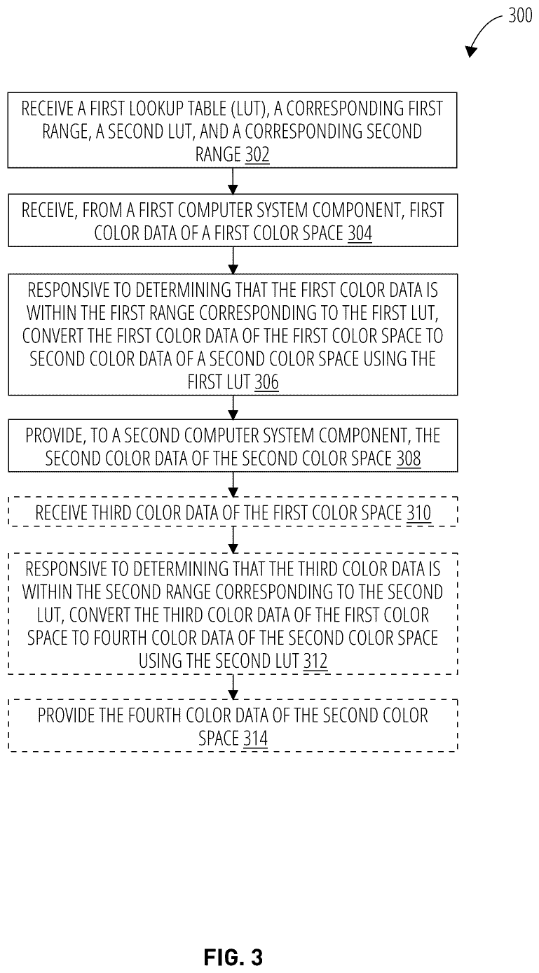

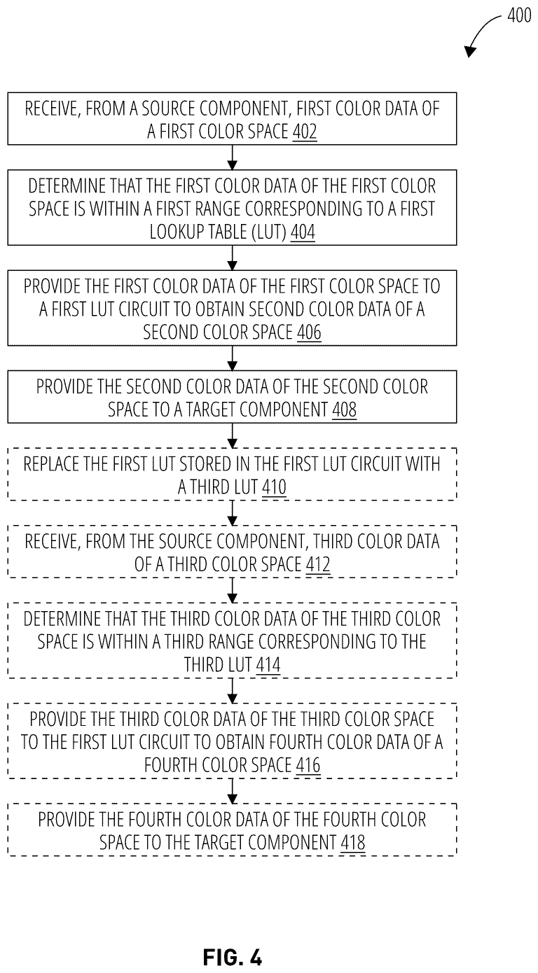

FIG. 3 is a flow diagram of an example method 300 for efficient color conversion using multiple lookup tables, according to at least one embodiment. FIG. 4 is a flow diagram of an example method 400 for efficient color conversion using multiple lookup tables, according to at least one embodiment.

Method 300 and/or method 400 can be performed using one or more processing units (e.g., CPUs, GPUs, accelerators, physics processing units (PPUs), data processing units (DPUs), etc.), which may include (or communicate with) one or more memory devices. In at least one embodiment, method 300 and/or method 400 can be performed using a processing device or processing devices. In at least one embodiment, method 300 can be performed using processing units of system 102 of FIG. 1. In at least one embodiment, method 400 can be performed by dual 3D LUTs circuit 202 of FIG. 2. In at least one embodiment, processing units performing any of methods 300 and/or method 400 can be executing instructions stored on a non-transient computer readable storage media. In at least one embodiment, any of method 300 and/or method 400 can be performed using multiple processing threads (e.g., CPU threads and/or GPU threads), individual threads executing one or more individual functions, routines, subroutines, or operations of the method. In at least one embodiment, processing threads implementing any of method 300 and/or method 400 can be synchronized (e.g., using semaphores, critical sections, and/or other thread synchronization mechanisms). Alternatively, processing threads implementing any of method 300 and/or method 400 can be executed asynchronously with respect to each other. Various operations of method 300 and/or method 400 can be performed in a different order compared with the order shown in FIG. 3 and/or FIG. 4. Some operations of any of method 300 and/or method 400 can be performed concurrently with other operations. In at least one embodiment, one or more operations shown in FIG. 3 and/or FIG. 4 may not always be performed.

Referring to FIG. 3, at block 302, processing units executing method 300 can receive a first lookup table (LUT), a corresponding first range, a second LUT, and a corresponding second range. In some embodiments, the first range is less than the second range. In some embodiments, the first range covers a portion of the second range.

At block 304, processing units can receive, from a first computer system component, first color data of a first color space. In some embodiments, the first computer system component is a parallel processing unit. In some embodiments, the first computer system component is a display interface.

At block 306, processing units can, responsive to determining that the first color data is within the first range corresponding to the first LUT, convert the first color data of the first color space to second color data of a second color space using the first LUT. In some embodiments, to convert the first color data of the first color space to the second color data of the second color space, processing units can apply an interpolation function to the first color data to obtain the second color data. In some embodiments, the interpolation function is at least one of a trilinear interpolation function, a tetrahedral interpolation function, a prism interpolation function, or a pyramidal interpolation function.

At block 308, processing units can provide, to a second computer system component, the second color data of the second color space. In some embodiments, the second computer system component is a display interface. In some embodiments, the second computer system component is a display panel.

In some embodiments, at block 310, processing units executing method 300 can receive third color data of the first color space. At block 312, processing units can, responsive to determining that the third color data is within the second range corresponding to the second LUT, convert the third color data of the first color space to fourth color data of the second color space using the second LUT. At block 314, processing units can provide the fourth color data of the second color space (e.g., to the second computer system component).

In some embodiments, processing units performing method 300 can, prior to determining that the first color data is within the first range corresponding to the first LUT, apply a non-linear transformation (e.g., a gamma correction transformation) to the first color data of the first color space. In some embodiments, processing units performing method 300 can, prior to providing the second color data of the second color space, apply an inverse non-linear transformation (e.g., an inverse gamma correction transformation) to the second color data of the second color space.

In some embodiments, processing units performing method 300 can receive a third LUT, a corresponding third range, and third color data of a third color space. Processing units can further, responsive to determining that the third color data of the third color space is within the third range, convert the third color data of the third color space to fourth color data of a fourth color space using the third LUT.

Referring to FIG. 4, at block 402, processing units executing method 400 can receive, from a source component, first color data of a first color space. In some embodiments, the source component is a parallel processing device. In some embodiments, the source component is a display interface.

At block 404, processing units can determine that the first color data of the first color space is within a first range corresponding to a first LUT. The first range can be smaller than a second range corresponding to a second LUT.

At block 406, processing units can provide the first color data of the first color space to a first LUT circuit to obtain second color data of a second color space. In some embodiments, to obtain the second color data of the second color space, the first LUT circuit can apply an interpolation function to the first color data of the first color space. In some embodiments, the interpolation function is at least one of a trilinear interpolation function, a tetrahedral interpolation function, a prism interpolation function, or a pyramidal interpolation function.

At block 408, processing units can provide the second color data of the second color space to a target component. In some embodiments, the target component is a display interface. In some embodiments, the target component is a display panel.

In some embodiments, processing units can receive third color data of the first color space, determine that the third color data of the first color space is within the second range corresponding to the second LUT, provide the third color data of the first color space to the second LUT circuit to obtain fourth color data of the second color space, and provide the fourth color data of the second color space.

In some embodiments, at block 410, processing units can replace the first LUT stored in the first LUT circuit with a third LUT. The third LUT can have a corresponding third range. At block 412, processing units can receive, from the source component, third color data of a third color space. At block 414, processing units can determine that the third color data of the third color space is within a third range corresponding to the third LUT. At block 416, processing units can provide the third color data of the third color space to the first LUT circuit to obtain fourth color data of a fourth color space. At block 418, processing units can provide the fourth color data of the fourth color space to the target component.

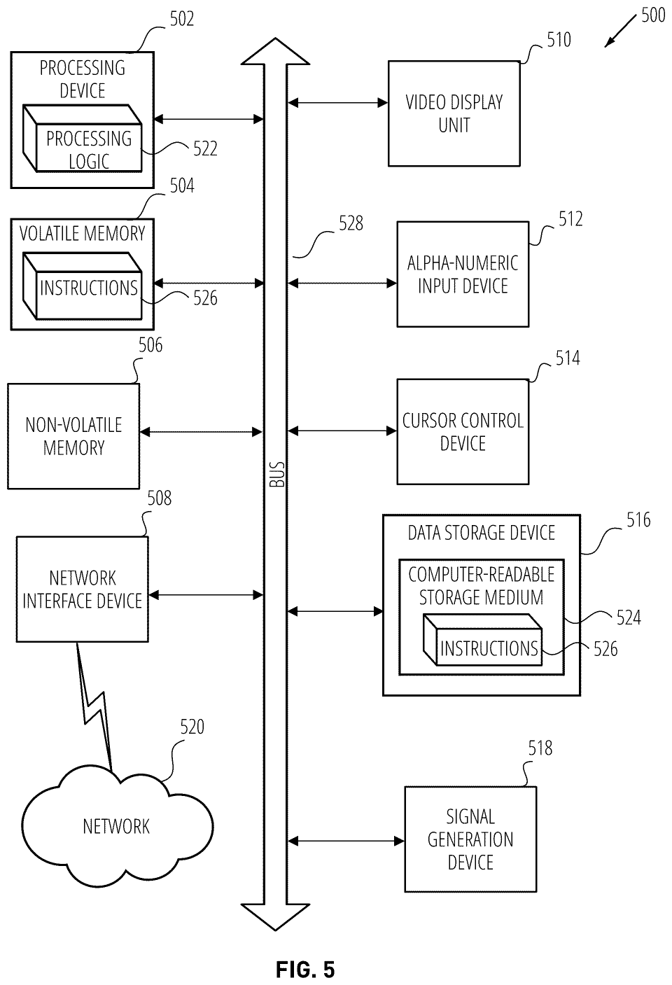

FIG. 5 is a block diagram illustrating an exemplary computer system, in accordance with at least one embodiment of the present disclosure. The computer system 500 can correspond to system 102, described with respect to FIG. 1. Computer system 500 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 528.

Processor (processing device) 502 represents one or more general-purpose processing devices such as a microprocessor, central processing unit, or the like, and may include processing logic 522. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for generating threat indicator alerts) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker). In some embodiments, computer system 500 may not include video display unit 510, input device 512, and/or cursor control device 514 (e.g., in a headless configuration).

The data storage device 516 can include a non-transitory machine-readable storage medium 524 (also computer-readable storage medium) on which is stored one or more sets of instructions 526 (e.g., for efficient color conversion using multiple lookup tables) embodying any one or more of the methodologies or functions described herein. The instructions 526 can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for efficient color conversion using multiple lookup tables. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving a first lookup table (LUT), a corresponding first range, a second LUT, and a corresponding second range, wherein the first range is less than the second range;
receiving, from a first computer system component, first color data of a first color space;
responsive to determining that the first color data is within the first range corresponding to the first LUT, converting the first color data of the first color space to second color data of a second color space using the first LUT; and
providing, to a second computer system component, the second color data of the second color space.

2. The method of claim 1, further comprising:
receiving third color data of the first color space;
responsive to determining that the third color data is within the second range corresponding to the second LUT, converting the third color data of the first color space to fourth color data of the second color space using the second LUT; and
providing the fourth color data of the second color space.

3. The method of claim 1, wherein the first computer system component is a parallel processing device, and the second computer system component is a display interface.

4. The method of claim 1, wherein the first computer system component is a display interface, and the second computer system component is a display panel.

5. The method of claim 1, further comprising:
prior to the determining that the first color data is within the first range corresponding to the first LUT, applying a non-linear transformation to the first color data of the first color space; and
prior to the providing the second color data of the second color space, applying an inverse non-linear transformation to the second color data of the second color space.

6. The method of claim 1, wherein the converting the first color data of the first color space to the second color data of the second color space using the first LUT comprises applying an interpolation function to the first color data to obtain the second color data, wherein the interpolation function is at least one of:
a trilinear interpolation function;
a tetrahedral interpolation function;
a prism interpolation function; or
a pyramidal interpolation function.

7. The method of claim 1, further comprising:
receiving a third LUT, a corresponding third range, and third color data of a third color space; and
responsive to determining that the third color data of the third color space is within the third range, converting the third color data of the third color space to fourth color data of a fourth color space using the third LUT.

8. A system comprising:
a memory; and
a processor communicatively coupled to the memory to perform operations comprising:
receiving a first lookup table (LUT), a corresponding first range, a second LUT, and a corresponding second range, wherein the first range is less than the second range;
receiving, from a first system component, first color data of a first color space;
responsive to determining that the first color data is within the first range corresponding to the first LUT, converting the first color data of the first color space to second color data of a second color space using the first LUT; and
providing, to a second system component, the second color data of the second color space.

9. The system of claim 8, the operations further comprising:
receiving third color data of the first color space;
responsive to determining that the third color data is within the second range corresponding to the second LUT, converting the third color data of the first color space to fourth color data of the second color space using the second LUT; and
providing the fourth color data of the second color space.

10. The system of claim 8, wherein the first system component is a parallel processing device, and the second system component is a display interface.

11. The system of claim 8, wherein the first system component is a display interface, and the second system component is a display panel.

12. The system of claim 8, the operations further comprising:
prior to the determining that the first color data is within the first range corresponding to the first LUT, applying a non-linear transformation to the first color data of the first color space; and
prior to the providing the second color data of the second color space, applying an inverse non-linear transformation to the second color data of the second color space.

13. The system of claim 8, wherein the converting the first color data of the first color space to the second color data of the second color space using the first LUT comprises applying an interpolation function to the first color data to obtain the second color data, wherein the interpolation function is at least one of:
a trilinear interpolation function;
a tetrahedral interpolation function;
a prism interpolation function; or
a pyramidal interpolation function.

14. The system of claim 8, the operations further comprising:
receiving a third LUT, a corresponding third range, and third color data of a third color space; and
responsive to determining that the third color data of the first color space is within the third range, converting the third color data of the third color space to fourth color data of a fourth color space using the third LUT.

15. A circuit comprising:
a first lookup table (LUT) circuit to store a first LUT and a second LUT circuit to store a second LUT, wherein the first LUT has a corresponding first range and the second LUT has a corresponding second range, wherein the first range is smaller than the second range; and
a control circuit selectively coupled to the first LUT circuit and the second LUT circuit, wherein the control circuit is to:
receive, from a source component, first color data of a first color space;
determine that the first color data of the first color space is within the first range corresponding to the first LUT;
provide the first color data of the first color space to the first LUT circuit to obtain second color data of a second color space; and
provide the second color data of the second color space to a target component.

16. The circuit of claim 15, wherein the control circuit is further to:
receive third color data of the first color space;
determine that the third color data of the first color space is within the second range corresponding to the second LUT;
provide the third color data of the first color space to the second LUT circuit to obtain fourth color data of the second color space; and
provide the fourth color data of the second color space.

17. The circuit of claim 15, wherein the source component is a parallel processing device, and the target component is a display interface.

18. The circuit of claim 15, wherein the source component is a display interface, and the target component is a display panel.

19. The circuit of claim 15, wherein to obtain the second color data of the second color space, the first LUT circuit applies an interpolation function to the first color data of the first color space, wherein the interpolation function is at least one of:
a trilinear interpolation function;
a tetrahedral interpolation function;
a prism interpolation function; or
a pyramidal interpolation function.

20. The circuit of claim 15, wherein the control circuit is further to:
replace the first LUT stored in the first LUT circuit with a third LUT, wherein the third LUT has a corresponding third range;
receive, from the source component, third color data of a third color space;
determine that the third color data of the third color space is within the third range corresponding to the third LUT;
provide the third color data of the third color space to the first LUT circuit to obtain fourth color data of a fourth color space; and
provide the fourth color data of the fourth color space to the target component.
